(19) United States
(12) Patent Application Publication
(10) Pub. No.: US 2009/0293831 A1
(43) Pub. Date: Dec. 3, 2009

(54) INTAKE DEVICE OF INTERNAL COMBUSTION ENGINE AND INTERNAL COMBUSTION ENGINE

(75) Inventor: Kenichi HARADA, Susono-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Aichi-Ken (JP)

(21) Appl. No.: 12/472,594

(22) Filed: May 27, 2009

(30) Foreign Application Priority Data
May 27, 2008 (JP) JP2008-138264

(51) Int. Cl. F02M 35/10

(52) U.S. Cl. 123/184.53

(57) ABSTRACT

Tumble control valves (TCV) are disposed downstream of a gas introducing passage inside intake paths and upstream of an opening of a gas branching passage.

### INCORPORATION BY REFERENCE

The disclosure of Japanese Patent Application No. 2008-138264 filed on May 27, 2008 including the specification, drawings and abstract is incorporated herein by reference in its entirety.

### BACKGROUND OF THE INVENTION

1. Field of the Invention

The invention relates to an intake device of an internal combustion engine provided with all intake manifold that distributes the intake air to intake ports of two banks and an intake path gas introducing device that introduces gas from outside an intake path into the intake path and to an internal combustion engine that incorporates the intake device.

2. Description of the Related Art

As a configuration of a device that introduces gas into an intake path, for example, an exhaust gas recirculation device (EGR device) is available in which an exhaust circulation passage is led to an intake manifold and gas is introduced from an introducing passage formed in the intake manifold into each intake path (see, for example, Japanese Patent Application Publication No. 6-81721 (JP-A-6-81721) (pages 4 and 5, FIGS. 1 to 3), Japanese Patent Application Publication No. 6-50216 (JP-A-6-50216) (page 3, FIGS. 1 to 4, 6, 8, and 9), Japanese Patent Application Publication No. 10-122071 (JP-A-10-122071) (pages 3 and 4, FIGS. 3 to 5), and Japanese Patent Application Publication No. 7-259657 (JP-A-7-259657) (page 3, FIG. 1)). In the two-bank internal combustion engines described in these patent documents, space is saved by forming the exhaust introducing passages between the arrays in a zone where the intake manifold is divided into two arrays.

In the configuration disclosed in Japanese Patent Application Publication No. 2002-38953 (JP-A-2002-38953) (page 5, FIG. 2), a high-speed port portion and a low-speed port portion are provided and a tumble flow is induced in the combustion chamber. The high-speed port portion serves only for the intake flow, whereas a passage valve is disposed on the low-speed port portion side and the EGR gas is introduced by opening an EGR gas introducing port from the EGR passage. The two ports merge in the location of intake valve, thereby introducing the high-speed intake flow and the low-speed EGR gas flow into the combustion chamber and generating a tumble flow.

An intake manifold is sometimes provided with an intake swirling control valve, such as the passage valve disclosed in JP-A-2002-38953, for inducing the swirling of intake gas inside the combustion chamber and controlling combustibility. In order to induce sufficient swirling inside the combustion chamber, it is important that such an intake swirling control valve be disposed as close to the combustion chamber as possible.

Therefore, where the intake swirling control valve is combined with a configuration designed to save space by forming an exhaust gas introducing passage between two manifold arrays, the intake swirling control valve is always disposed on the downstream side in the intake flow, as described in JP-A-6-81721, JP-A-6-50216, JP-A-10-122071, and JP-A-7-259657. As a result, the exhaust gas introducing passage is disposed upstream of the intake swirling control valve, in particular in a portion where the two manifold arrays are separated, as disclosed in JP-A-10-122071 and JP-A-7-259657.

However, where the exhaust gas introducing passage is disposed on the upstream side of the intake flow, the intake swirling control valve is directly exposed to the exhaust gas and the opening degree control of the intake swirling control valve can be inhibited by adhesion of deposits or adhesion of condensed water.

### SUMMARY OF THE INVENTION

The invention makes it possible to reduce the effect produced by introduced gas on the intake swirling control valve even in a configuration in which a gas introducing passage, such as an EGR gas passage, is thus formed in a separation zone of two manifold arrays and the intake swirling control valve is disposed downstream of the gas introducing passage.

An intake device according to the first aspect of the invention intake device of an internal combustion engine includes: an intake manifold in which two manifold arrays having a plurality of intake paths formed therein are aggregated on an upstream side and separated on a downstream side of an intake gas flow to distribute the intake gas to intake ports of two banks via the intake paths; and an intake path gas introducing device that introduces gas from outside the intake paths into the intake paths, wherein the intake path gas introducing device has a gas introducing passage formed in an arrangement direction of the manifold arrays by surrounding a space in a separation portion of the two manifold arrays, and a gas branching passage that branches off from the gas introducing passage for each intake path and opens in the intake paths downstream, in the intake paths, of the gas introducing passage; and intake swirling control valves disposed in the intake path downstream of the gas introducing passages and in the intake paths upstream of an opening position of the gas branching passage for each intake path.

The intake swirling control valves are disposed in the intake paths downstream of the gas introducing passage. Because the intake swirling control valves are thus disposed closer to the combustion chambers than the gas introducing passage, sufficient intake gas swirling can be induced in the combustion chambers.

Actual gas introduction from the gas introducing passage to the intake paths is performed by the gas branching passage that is open in the intake paths downstream of the gas introducing passage. The opening position of the gas branching passage is downstream of the intake swirling control valves. As a result, the components contained in the gas produce no effect on the intake swirling control valves. For example, the effect produced on the opening-closing control of the intake swirling control valves by adhesion of deposits or adhesion of condensed water is reduced.

Therefore, the effect produced by the introduction of gas on the intake swirling control valves can be reduced even in a configuration in which a gas introducing passage, such as an EGR introducing passage, is formed in the separation portion of two manifold arrays and the intake swirling control valves are disposed downstream of the gas introducing passage.

The gas branching passage may branch off from the lowermost portion in the gas introducing passage in the gravity force direction for each intake path.

As a result, in a case where condensed water is generated in the gas introducing passage when the internal combustion engine is stopped, practically the entire condensed water located inside the gas introducing passage can be rapidly caused to flow down into the intake paths located downstream of the intake swirling control valves. Therefore, water is prevented from remaining and freezing in the gas introducing passage, and the occurrence of troubles associated with the introduction of gas when the internal combustion engine is started or immediately thereafter can be prevented.

The gas branching passage may be open in the vicinity of downstream ends of the intake paths. With such a configuration, a region from the gas introducing passage to the opening position of the gas branching passage expands and the degree of freedom in disposing the intake swirling control valves is increased. In particular, the intake swirling control valves can be also disposed sufficiently close to the combustion chambers and sufficient intake swirling can be obtained.

The intake swirling control valves may be disposed in the vicinity of downstream ends of the intake paths inside a region on the upstream side of the opening position of the gas branching passage.

By so disposing the intake swirling control valves in the vicinity of a downstream end in the intake paths in the aforementioned region, it is possible to induce effectively the swirling inside the combustion chambers.

When the intake device is mounted on an internal combustion engine, the intake paths may be disposed to face downward along the gravity force direction, on the downstream side of the gas introducing passage.

As a result, the condensed water located in the gas introducing passage is smoothly discharged from the gas branching passage and the opening thereof when the internal combustion engine is stopped, and the condensed water discharged from the opening is reliably separated from the intake swirling control valve.

The gas introducing passage and the gas branching passage may be formed integrally with an intake pipe that forms the intake paths.

Because of such integral formation, in particular integration of the gas introducing passage with the intake pipe, the rigidity of the entire intake manifold can be greatly increased, thereby improving the endurance. Furthermore, because the gas branching passage is also formed integrally with the intake pipe, the complexity level of the shape of the entire intake manifold is not raised and the endurance of the intake manifold is further increased.

The intake device, except the intake swirling control valves, may be formed integrally. By performing such an integral forming by metal casting or injection molding of a resin, the rigidity of the intake manifold can be increased. Therefore, the endurance is increased.

The intake manifold may be formed as a sub-intake manifold to connect a surge tank with the intake ports.

Thus, the intake manifold may be configured as a sub-intake manifold and the above-described effects can be demonstrated. The gas introducing passage may introduce exhaust gas of the internal combustion engine in the intake gas.

The object of introduction with the gas introducing passage may be exhaust gas, and the above-described effects can be demonstrated by providing an intake path gas introducing device as thus described. The gas introducing passage may introduce blow-by gas of the internal combustion engine or fuel vapor produced by fuel evaporation from a fuel tank in the intake gas.

The object of introduction with the gas introducing passage may be blow-by gas or fuel vapor, and the above-described effects can be demonstrated by providing an intake path gas introducing device as thus described.

The intake swirling control valves may be tumble control valves. In particular, in a case where tumble control valves are disposed as intake swirling control valves inside the intake paths, the effect produced by the gas components can be inhibited and the occurrence of obstacles to the opening-closing control of the tumble control valves can be reduced.

An internal combustion engine according to the second aspect of the invention includes the intake device according to the first aspect that is incorporated in a cylinder head of the internal combustion engine; and fuel injection valves disposed between two banks.

By so disposing the fuel injection valves between two banks, the fuel injection valves are disposed in a state of being surrounded by the banks and the gas introducing passage of the intake manifolds. As a result, as described hereinabove, the effect produced by the introduction of gas on the intake swirling control valves is reduced. Moreover, the sound emitted from the fuel injection valves is shielded and a high noise reducing effect can be demonstrated.

In the second aspect, the fuel injection valve may inject fuel into a combustion chamber. By disposing the fuel injection valves in the above-described manner in a diesel engine or an internal fuel injection gasoline engine in which a fuel injection valve injects fuel into a combustion chamber, it is possible to reduce effectively the noise produced by the fuel injection valves of the internal combustion engine.

An intake device of an internal combustion engine according to the third aspect of the invention includes an intake manifold in which two manifold arrays having a plurality of intake paths formed therein are aggregated on an upstream side and separated on a downstream side of an intake gas flow to distribute the intake gas to intake ports of two banks via the intake paths; and an intake path gas introducing device that introduces gas from outside the intake paths into the intake paths, wherein the intake path gas introducing device has a gas introducing passage formed in an arrangement direction of the manifold arrays by surrounding a space in a separation portion of the two manifold arrays, and a gas branching passage that branches off from the gas introducing passage and opens in the intake paths; and intake swirling control valves being disposed in the intake paths upstream of an opening position of the gas branching passage for each intake path.

The intake swirling control valves may be disposed so that a length from the opening of the gas branching passage to the intake swirling control valves in the intake gas flow direction is less than the length from the opening of the gas branching passage to the gas introducing passage in the gas flow direction.

### BRIEF DESCRIPTION OF THE DRAWINGS

The features, advantages, and technical and industrial significance of this invention will be described in the following detailed description of example embodiments of the invention with reference to the accompanying drawings, in which line numerals denote like elements, and wherein:

FIG. 1 is a partially cut perspective view of a sub-intake manifold of Embodiment 1;

FIG. 2 is a partially cut bottom perspective view of the sub-intake manifold of Embodiment 1;

FIG. 3 is a plan view of the sub-intake manifold of Embodiment 1;

FIG. 4 is a bottom view of the sub-intake manifold of Embodiment 1;

FIGS. 5A and 5B are a left side view and a front view of the sub-intake manifold of Embodiment 1;

FIG. 6 is a cut perspective view of an intake path of the sub-intake manifold of Embodiment 1;

FIG. 7 is a vertical sectional view of the sub-intake manifold of Embodiment 1;

FIG. 8 is an explanatory drawing illustrating the principal configuration of the internal combustion engine of Embodiment 2; and

FIGS. 9A, 9B, and 9C are vertical sectional views of sub-intake manifolds of other embodiments.

### DETAILED DESCRIPTION OF EMBODIMENTS

### Embodiment 1

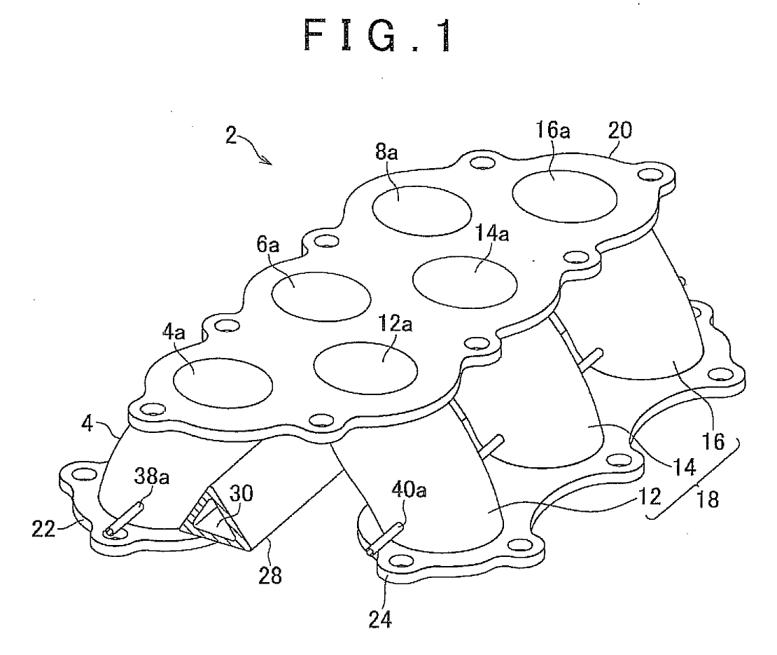

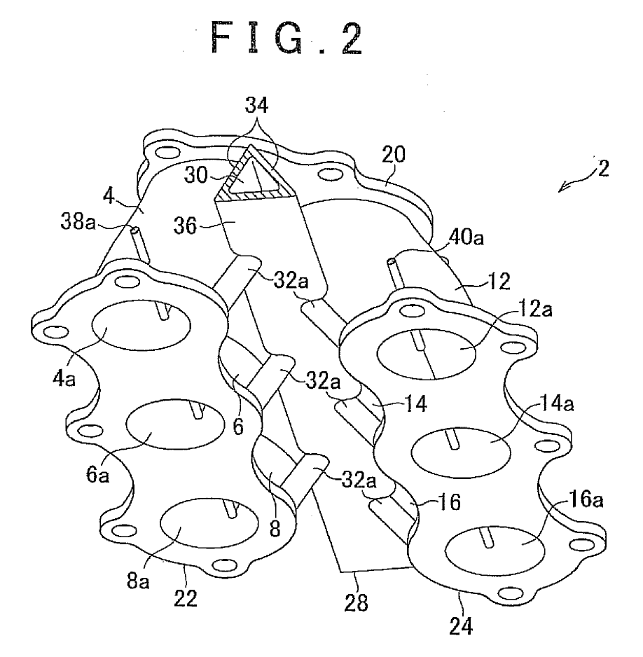

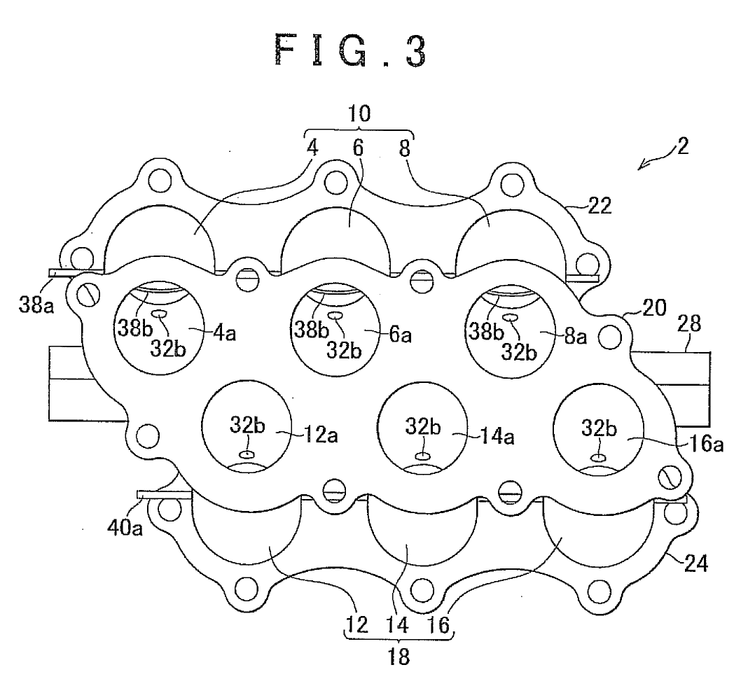

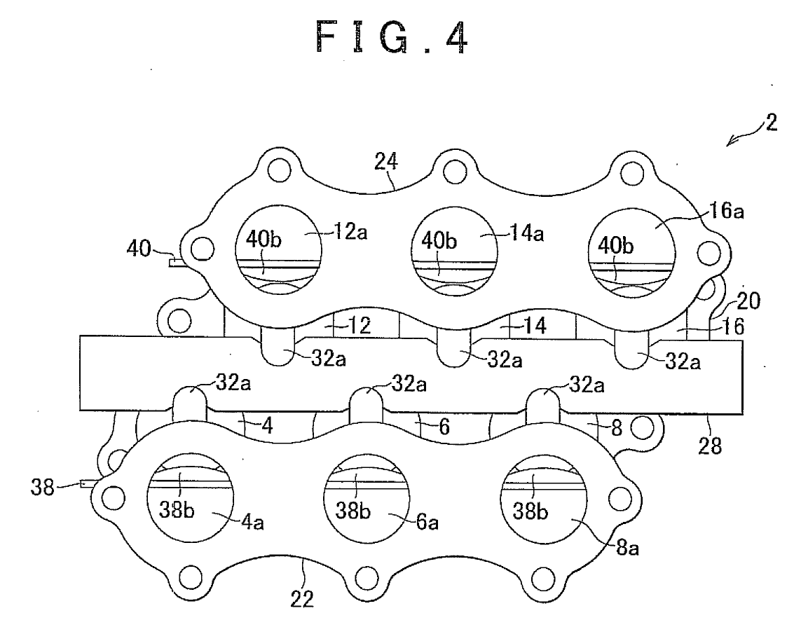

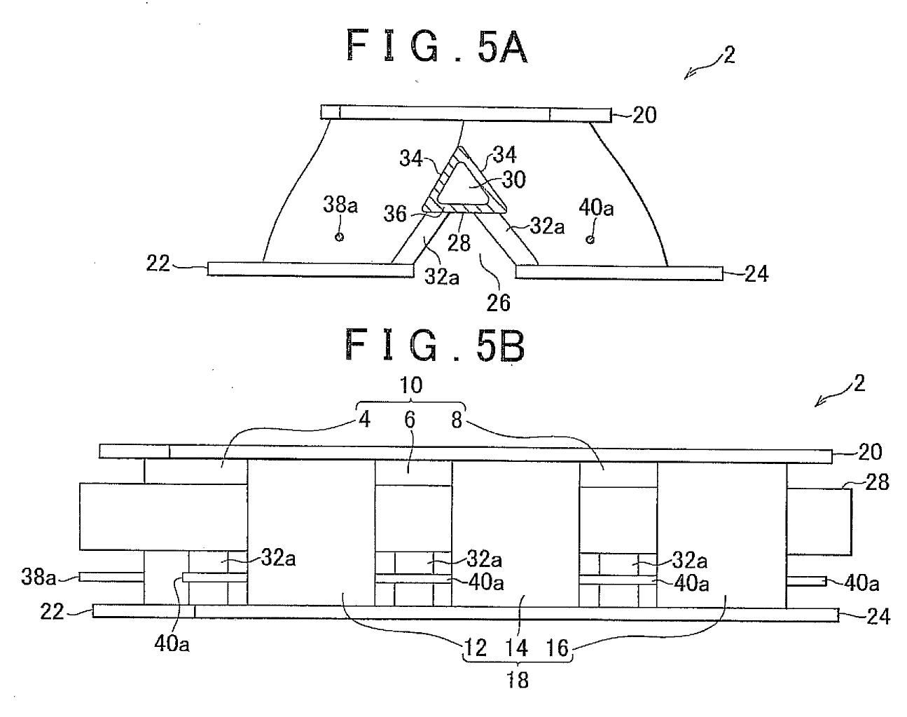

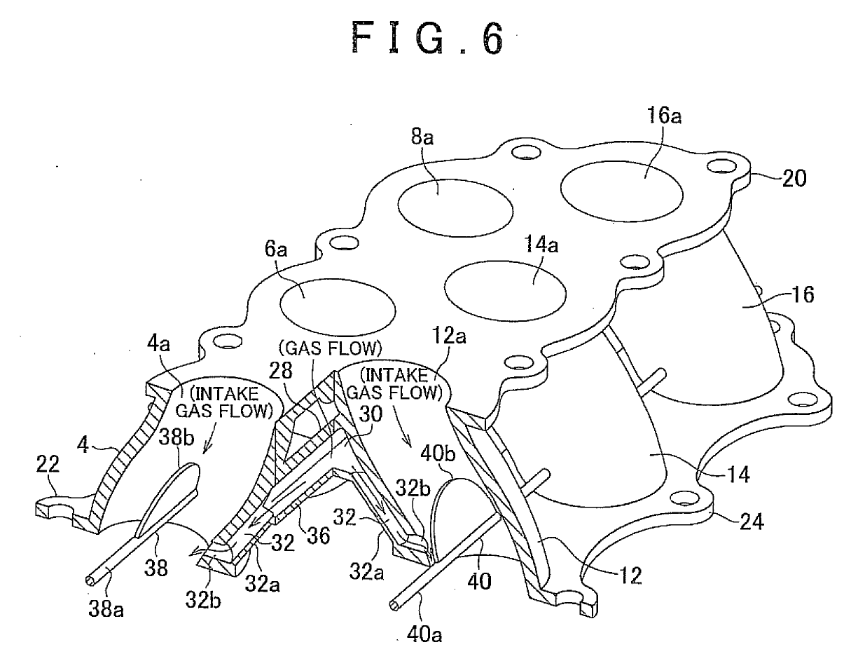

FIGS. 1 to 6 show a configuration of a sub-intake manifold 2 of Embodiment 1 to which the invention is applied. FIG. 1 is a partially cut perspective view, FIG. 2 is a partially cut bottom perspective view, FIG. 3 is a plan view, FIG. 4 is a bottom view, FIG. 5A is a left side view, FIG. 5B is a front view, and FIG. 6 is a cut perspective view of an intake path.

The sub-intake manifold 2 constitutes part of an intake manifold of a V-type six-cylinder internal combustion engine, and is provided with a manifold array 10 for a right bank in which three intake pips 4, 6, and 8 for a right bank are arranged in a row and a manifold array 18 for a left bank in which three intake pipes 12, 14, and 16 for a left bank are arranged in a row.

The two manifold arrays 10, 18 that are aggregated on the intake upstream side and separated on the intake downstream side are assembled in one flange 20 on the aggregation side. Each of two manifold arrays 10, 18 is connected to an intake manifold portion formed on a surge tank side by the flange 20.

On the separation side, the manifold arrays 10, 18 are completely separated in two rows, and flanges 22, 24 are provided at distal ends of respective rows. The flange 22 for the right bank connects to the cylinder head of the right bank, and connects respectively the intake pipes 4 to 8 to the intake ports of each cylinder formed in a cylinder head. The flange 24 for the left bank connects to a cylinder head of the left bank, and connects the intake pipes 12 to 16 to the intake ports of each cylinder formed in the cylinder head. Therefore, the sub-intake manifold 2 is present between the surge tank and cylinder head, thereby making it possible to supply an external air that is sucked in by the surge tank as intake air into intake ports of the cylinders.

As shown in FIG. 5A, an intake path gas introducing device 28 is formed in a columnar space 26 formed in the arrangement direction between the two manifold arrays 10, 18. The intake path gas introducing device 28 is provided with a gas introducing passage 30 and a gas branching passage 32.

The gas introducing passage 30 is a passage in the form of a substantially triangular column and is formed in the arrangement direction of the manifold arrays 10, 18 by surrounding a space in the separation portion of the two manifold arrays 10, 18. Either of the ends of the gas introducing passage 30 is closed, and exhaust gas of the internal combustion engine is supplied as the EGR gas via an EGR valve into the other end.

The gas branching passage 32 is branched off from the gas introducing passage 30 for each intake pipe 4 to 8, 12 to 16. The gas branching passage 32 is constituted by a frame 32a and an opening 32b that communicates with the intake paths 4a, 6a, 8a, 12a, 14a, 16a in the intake pipes 4 to 8, 12 to 16 downstream of the gas introducing passage 30.

In the sub-intake manifold 2, the intake pipes 4 to 8, 12 to 16, flanges 20, 22, 24, frame of the gas intake passage 30, and frame 32a of the gas branching passage 32 are formed integrally by metal casting, in this case by casting of an aluminum alloy or an iron alloy.

The frame of the gas introducing passage 30 is constituted by a side wall portion 34 in the form of inverted V and a plate-shaped bottom wall portion 36. Among these portions, the intake pipes 4 to 8, 12 to 16 are integrally formed in a joined state mainly in the portions of the side wall portion 34 in the form of inverted V. As a result, the side wall portion 34 in the form of inverted V and plate-shaped bottom wall portion 36 surround part of the columnar space 26 extending in the arrangement direction between the manifold arrays 10, 18, thereby forming the gas introducing passage 30.

In a portion where the gas introducing passage 30 is in contact with the intake pipes 4 to 8, 12 to 16, the gas branching passage 32 corresponding to each intake path 4a to 8a, 12a to 16a is branched off from the lowermost portion in the gravity force direction. The frame 32a of the gas branching passage 32 is integrated in a state in which the frame extends downstream in a state of joining to the intake pipes 4 to 8, 12 to 16 and reaches the flanges 22, 24. Furthermore, the gas branching passage 32 is provided in the lowermost portion thereof with an opening 32b that is open inside the intake paths 4a to 8a, 12a to 1 6a, and the exhaust gas located inside the gas branching passage 32 is introduced in the intake gas located in the intake paths 4a to 8a, 12a to 16a.

Each manifold array 10, 18 is provided with a respective tumble control valve 38, 40 that corresponds to the intake swirling control valve. The tumble control valves 38, 40 are disposed in a state in which valve shafts 38a, 40a provided integrally with the manifold arrays 10, 18 pass through the respective intake pipes 4 to 8, 12 to 16 in a region between gas introducing passage 30 and the opening 32b of the gas branching passage 32 inside the intake paths 4a to 8a, 12a to 16a.

Valve bodies 38b, 40b are attached to the valve shafts 38a, 40a for each intake path 4a to 8a, 12a to 16a. As a result, one side in the direction perpendicular to the intake flow direction in each intake path 4a to 8a, 12a to 16a, more particularly a side where the opening 32b of the gas branching passage 32 is present, is opened and closed by swinging motion of the valve shafts 38a, 40a. Therefore, the degree of intake gas swirling that is generated inside a combustion chamber of each cylinder can be regulated.

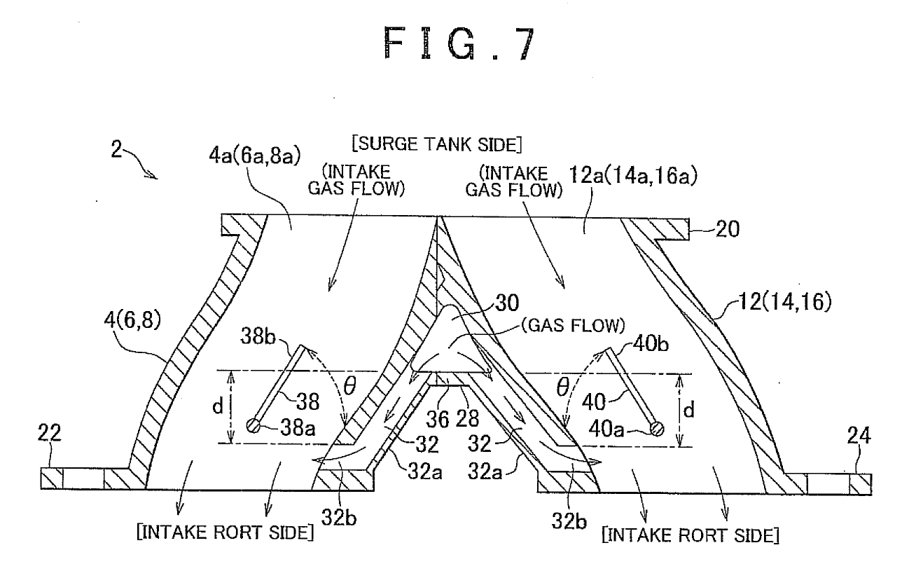

As shown in the vertical section view in FIG. 7, intake gas is introduced from an upstream side where a surge tank is present in each intake path 4a to 8a, 12a to 16a, and the intake flow is directed toward the intake port via the sub-intake manifold 2, as shown by the arrows.

The tumble control valves 38, 40 are disposed so that the valve shafts 38a, 40a thereof are positioned on the intake downstream side of the gas introducing passage 30 in the intake paths 4a to 8a, 12a to 16a and inside the region d upstream of the position of the opening 32b of the gas branching passage 32. Thus, the tumble control valves 38, 40 are disposed so that the valve shafts 38a, 40a are positioned upstream of the position of the opening 32b of the gas branching passage 32 in the intake paths 4a to 8a, 12a to 16a and the length from the position of the opening 32b to the valve shaft 38a, 40a in the intake gas flow direction is less than the length from the position of the opening 32b to the gas introducing passage 30 in the gas flow direction. In FIG. 7, the swinging movement of the valve bodies 38b, 40b of the tumble control valves 38, 40 is represented by a swinging range θ.

Therefore, where the EGR gas is introduced from the exhaust side in the intake paths 4a to 8a, 12a to 16a through the gas introducing passage 30 and gas branching passage 32, the EGR gas will be introduced downstream of the tumble control valves 38, 40, as shown by the arrows. This EGR gas will then flow down together with the intake gas flow to the intake port side. As a result, the tumble control valves 38, 40 are not directly exposed to the EGR gas,

The following effects can be obtained with the above-described Embodiment 1. (A) The tumble control valves 38, 40 are disposed, as shown in FIG. 7, downstream of the gas introducing passage 30 in the intake paths 4a to 8a, 12a to 16a and upstream of the position of the opening 32b of the gas branching passage 32. Therefore, because the tumble control valves 38, 40 are brought closer to the combustion chambers of cylinders than the gas introducing passage 30, sufficient swirling can be induced inside the combustion chambers.

Actual introduction of EGR gas from the gas introducing passage 30 is performed by the gas branching passages 32 that are open downstream of the gas introducing passage 30 in the intake paths 4a to 8a, 12a to 16a. The position of the opening 32b of the gas branching passage 32 is downstream of the tumble control valves 38, 40, in particular downstream in the gravity force direction. As a result, the effect of components contained in the EGR gas, for example, hindering of opening-closing control of the tumble control valves 38, 40 by adhesion of deposits or adhesion of condensed water can be effectively inhibited.

Therefore, the tumble control valves 38, 40 can be protected from the effect produced by the introduction of EGR gas even in a configuration in which the gas introducing passage 30 is formed in the separation portion of two manifold arrays 10, 18 and the tumble control valves 38, 40 are disposed downstream of the gas introducing passage.

In particular, the gas branching passage 32 is open in the vicinity of the downstream end of the intake paths 4a to 8a, 12a to 16a. As a result, a state with a wide region d from the gas introducing passage 30 to the opening 32b of the gas branching passage 32 can be obtained and the degree of freedom in disposing the tumble control valves 38, 40 is high.

(B) The gas branching passage 32 is branched off from the lowermost portion in the gravity force direction in the gas introducing passage 30 in each intake path 4a to 8a, 12a to 16a. Therefore, in a case where condensed water is generated in the gas introducing passage 30, practically the entire condensed water can be rapidly and reliably caused to flow down into the intake paths 4a to 8a, 12a to 16a located downstream of the tumble control valves 38, 40. Therefore, water is prevented from remaining and freezing in the gas introducing passage 30 when the internal combustion engine is stopped. As a result, the occurrence of troubles associated with the introduction of EGR gas when the internal combustion engine is started or immediately thereafter can be prevented.

(C) The frame (side wall portion 34 in the form of inverted V and plate-shaped bottom wall portion 36) of the gas introducing passage 30 and the frame 32a of the gas branching passage 32 are integrally cast from a metal together with the intake pipes 4 to 8, 12 to 16. Therefore, the rigidity of the sub-intake manifold 2 is increased. In particular, since the gas introducing passage 30 is integrated with the intake pipes 4 to 8, 12 to 16, the rigidity of the entire sub-intake manifold 2 is greatly raised and endurance of the sub-intake manifold 2 is increased. Furthermore, since the gas branching passage 32 is also formed integrally with the intake pipes 4 to 8, 12 to 16, the complexity level of the entire sub-intake manifold 2 is not increased and the endurance of the sub-intake manifold 2 is further increased,

### Embodiment 2

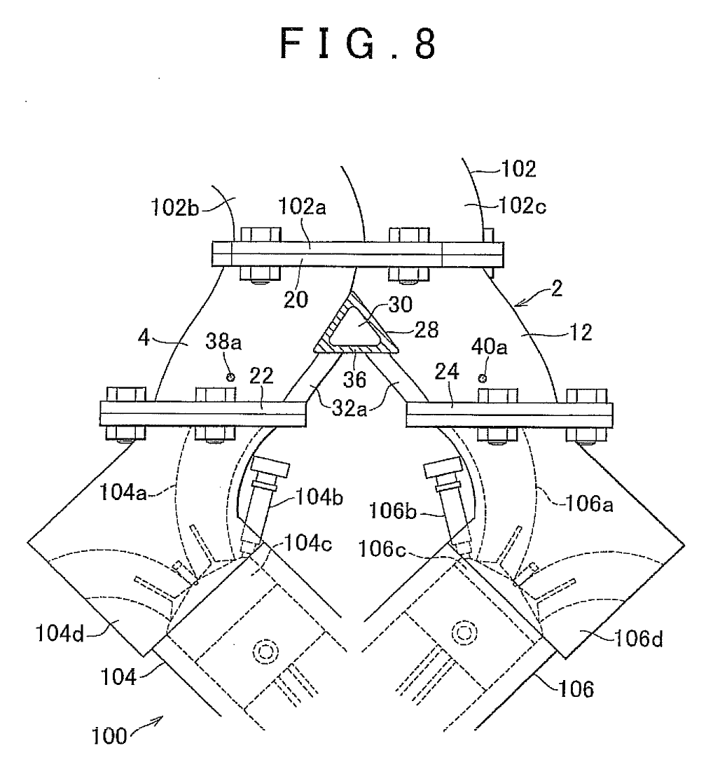

FIG. 8 shows a configuration of Embodiment 2. FIG. 8 shows a state in which the sub-intake manifold 2 of Embodiment 1 is incorporated in a V-type six-cylinder internal combustion engine 100. Therefore, the explanation will be conducted with reference to FIGS. 1 to 7. The internal combustion engine 100 is a gasoline engine of an internal fuel injection gasoline engine.

The sub-intake manifold 2 is joined with bolts to a flange 102a on the side of the surge tank 102 in the flange 20 on the intake upstream side. The external air is supplied as intake gas from branch pipes 102b, 102c on the side of the surge tank 102 into intake pipes 4 to 8 and 12 to 16. The sub-intake manifold 2 channels and supplies the intake gas to the intake ports 104a, 106a of each cylinder in each bank 104, 106 of the internal combustion engine 100.

Because the internal combustion engine 100 is of an in-cylinder fuel injection type, as mentioned hereinabove, fuel injection valves 104b, 106b provided in each cylinder directly inject the fuel into combustion chambers 104c, 106c. The fuel injection valves 104b, 106b are provided in cylinder heads 104d, 106d, and all the fuel injection valves 104b, 106b are disposed between the banks 104, 106 of the internal combustion engine 100. As a result, the fuel injection valves 104b, 106b are disposed below the gas introducing passage 30, in particular below the plate-shaped bottom wall portion 36 of the sub-intake manifold 2.

The following effects can be obtained with the above-described Embodiment 2. (A) The effects of Embodiment 1 are demonstrated in the internal combustion engine 100. In addition, because the fuel injection valves 104b, 106b for direct injection are disposed below the gas introducing passage 30 of the sub-intake manifold 2, the fuel injection valves 104b, 106b are surrounded by the banks 104, 106 and the sub-intake manifold 2. Therefore, noise emitted from the fuel injection valves 104b, 106b is effectively shielded and a high noise reduction effect can be demonstrated.

### Other Embodiments

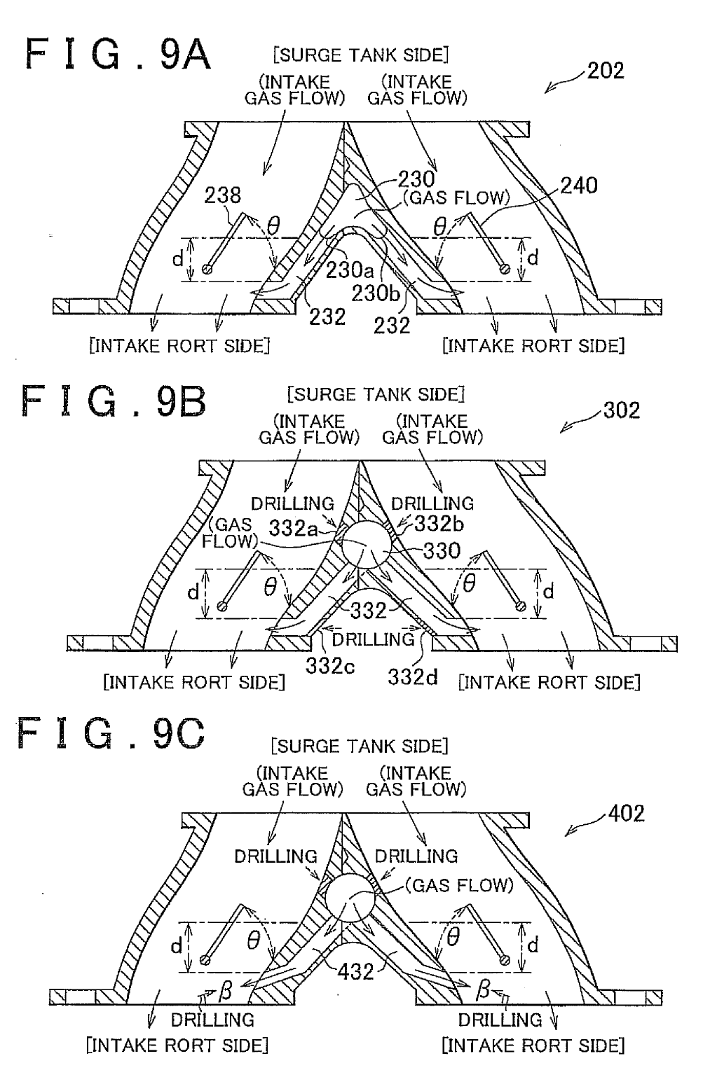

(a) In the intake path gas introducing device 28 of Embodiment 1, the gas introducing passage 30 is formed as a passage of a substantially triangular columnar shape, as shown in FIGS. 6 and 7, and the gas branching passages 32 branch off from both sides on the inner surface of the plate-shaped bottom wall portion 36 that corresponds to the bottom portion of the gas introducing passage 30. However, in order to increase further the effect of discharging the condensed water when the internal combustion engine is stopped, it is possible to lower the portion where a gas branching passage 232 branches off from with respect other parts (central part) of the bottom portion by lowering both side portions 230a, 230b of the bottom portion of a gas introducing passage 230, as in the sub-intake manifold 202 shown in FIG. 9A. As a result the condensed water will be collected in both side portions 230a, 230b of the bottom portion of the gas introducing passage 230 also when the internal combustion engine is stopped and, therefore, the discharge of the condensed water downstream of tumble control valves 238, 240 via the gas branching passage 232 can be enhanced.

(b) A gas introducing passage 330 of a sub-intake manifold 302 may also have a circular columnar shape such as shown in FIG. 9B. In this case, the sub-intake manifold 302 is formed in a solid form in which the gas introducing passage 330 is absent during casting. Then, the gas introducing passage 330 can be easily formed by drilling the separation portion of the two manifold arrays in the arrangement direction and closing one end portion. Furthermore, the gas branching passage 332 can be also easily formed in a similar manner by performing drilling and closing the unnecessary through holes 332a, 332b, 332c, 332d that are formed during drilling, as shown by arrows in FIG. 9B. As a result, casting of the sub-intake manifold 302 can be facilitated and the total production cost can be reduced. In this configuration, a gas branching passage 332 branches off from a position in the gas introducing passage 330 that is lower than other portions. Therefore, the condensed water is collected in the branched portion of the gas introducing passage 330 even when the internal combustion engine is stopped. As a result, the discharge of the condensed water downstream of tumble control valves via the gas branching passage 332 can be enhanced.

(c) The outlet side of a gas branching passage 432 (or the entire gas branching passage 432) may be formed by drilling at an angle β with respect to the horizontal direction from the intake port side, as in the gas branching passage 432 formed in a sub-intake manifold 402 shown in FIG. 9C. As a result, closing the through holes 332c, 332d such as shown in FIG. 9B is unnecessary and the production cost is further reduced. In addition, where the outlet side of the gas branching passage 432 faces obliquely and downward, the condensed water can be rapidly and more reliably discharged.

(d) In the above-described embodiments, as shown in FIG. 7, the tumble control valves 38, 40 are disposed so that the valve shafts 38a, 40a thereof are located downstream of the gas introducing passage 30 in the intake paths 4a to 8a, 12a to 16a and also in the region d upstream of the position of the opening portion 32b of the gas branching passage 32. The valve shafts may be also disposed in the region d in a position that is the closest to the downstream side end of the intake paths 4a to 8a, 12a to 16a, that is, in the lower end position of the region d. As a result, the intake gas swirling can be induced in the combustion chambers even more effectively.

(e) In the embodiments, gases introduced into the intake gas by the intake path gas introducing device were EGR. For example, a blow-by gas or fuel vapor (purge gas from a canister) that is produced by fuel evaporation from the fuel tank may be also introduced into the intake gas. In this case, the effect described in the embodiments can be demonstrated.

(f) As shown in FIGS. 1 and 3, in Embodiment 1, in the flange 20 on the aggregation side, the aggregation state of the intake paths 4a to 8a, 12a to 16a is not a perfect single row, but a configuration in which the intake paths are perfectly aggregated in a single row may be also used.

(g) In the embodiments, sub-intake manifolds located between a surge tank and intake ports were considered by way of example, but the configuration of the intake path gas introducing device 28 of Embodiment 1 can be also applied to the intake manifold that is molded integrally by casting or the like with the surge tank and such a configuration can demonstrate a similar effect.

(h) In Embodiment 1 (FIGS. 1 to 7), the plate-shaped bottom wall portion 36 is molded integrally with the side wall portion 34 in the form of inverted V. Alternatively, components other than the plate-shaped bottom wall portion 36 may be integrally molded, and the entire body may be then integrated by joining the plate-shaped bottom wall portion 36 to the integrated molded body.

(i) In Embodiment 1, in the sub-intake manifold 2, the intake pipes 4 to 8, 12 to 16, flanges 20, 22, 24, frame (side wall portion 34 in the form of inverted V and plate-shaped bottom wall portion 36) of the gas introducing passage 30, and frame 32a of the gas branching passage 32 are obtained by metal casting, but they may be also integrally formed by injection molding of a resin.

(j) In the above-described embodiment, a gasoline engine is explained as an internal combustion engine by way of example, but the invention is also applicable to a diesel engine and can demonstrate similar effects in this application.

What is claimed is:

1. An intake device of an internal combustion engine, comprising:
an intake manifold in which two manifold allays having a plurality of intake paths formed therein are aggregated on an upstream side and separated on a downstream side of an intake gas flow to distribute the intake gas to intake ports of two banks via the intake paths; and
an intake path gas introducing device that introduces gas from outside the intake paths into the intake paths, wherein the intake path gas introducing device has a gas introducing passage formed in an arrangement direction of the manifold arrays by surrounding a space in a separation portion of the two manifold arrays, and a gas branching passage that branches off from the gas introducing passage for each intake path and opens in the intake paths downstream, in the intake paths, of the gas introducing passage; and
intake swirling control valves disposed in the intake paths downstream of the gas introducing passage and in the intake paths upstream of an opening position of the gas branching passage for each intake path.

2. The intake device according to claim 1, wherein the gas branching passage branches off from the lowermost portion in the gas introducing passage in the gravity force direction for each intake path.

3. The intake device according to claim 1, wherein the gas branching passage opens in the vicinity of downstream ends of the intake paths.

4. The intake device according to claim 1, wherein the intake swirling control valves are disposed in the vicinity of downstream ends of the intake paths inside a region on the upstream side of the opening position of the gas branching passage.

5. The intake device according to claim 1, wherein when the intake device is mounted on an internal combustion engine, the intake paths are disposed to face downward along the gravity force direction, on the downstream side of the position of the gas introducing passage.

6. The intake device according to claim 1, wherein the gas introducing passage and the gas branching passage are formed integrally with an intake pipe that forms the intake paths.

7. The intake device according to claim 6, wherein the intake device, except the intake swirling control valves, is formed integrally by metal casting or injection molding of a resin.

8. The intake device according to claim 1, wherein the intake manifold is formed as a sub-intake manifold to connect a surge tank with the intake ports.

9. The intake device according to claim 1, wherein the gas introducing passage introduces exhaust gas of an internal combustion engine into the intake gas.

10. The intake device according to claim 1, wherein the gas introducing passage introduces blow-by gas of an internal combustion engine or fuel vapors produced by fuel evaporation from a fuel tank into the intake gas.

11. The intake device according to claim 1, wherein the intake swirling control valves are tumble control valves.

12. A internal combustion engine comprising:
the intake device according to claim 1 that is incorporated in a cylinder head of the internal combustion engine; and
fuel injection valves disposed between two banks.

13. The internal combustion engine according to claim 12, wherein the fuel injection valve injects fuel into a combustion chamber.

14. An intake device of an internal combustion engine, comprising:
an intake manifold in which two manifold arrays having a plurality of intake paths formed therein are aggregated on an upstream side and separated on a downstream side of an intake gas flow to distribute the intake gas to intake ports of two banks via the intake paths;
an intake path gas introducing device that introduces gas from outside the intake paths into the intake paths, wherein the intake path gas introducing device has a gas introducing passage formed in an arrangement direction of the manifold arrays by surrounding a space in a separation portion of the two manifold arrays, and a gas branching passage that branches off from the gas introducing passage and opens in the intake paths; and
intake swirling control valves being disposed in the intake paths upstream of an opening position of the gas branching passage for each intake path.

15. The intake device according to claim 14, wherein the intake swirling control valves are disposed so that a length from the opening of the gas branching passage to the intake swirling control valves in the intake gas flow direction is less than the length from the opening of the gas branching passage to the gas introducing passage in the gas flow direction.
